(19) United States
(12) Patent Application Publication
(10) Pub. No.: US 2007/0285679 A1
(43) Pub. Date: Dec. 13, 2007

(54) Image processing apparatus, image processing method and image processing program

(75) Inventor: Hiroki Umezawa, Izunokuni-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/450,225

(22) Filed: Jun. 9, 2006

(51) Int. Cl. G06K 15/02

(52) U.S. Cl. 358/1.2

(57) ABSTRACT

It is an object of the invention to provide a technique for preventing image quality deterioration of a print image involved in adjustment of color conversion parameters in image formation processing.

An image processing apparatus includes: a change information acquiring unit that acquires, when first brightness setting information is changed, information on the change, the first brightness setting information defining, in printing a color that can be represented by only a color material of black, brightness that should be represented using the color material; a calculating unit that calculates, on the basis of the change information acquired by the change information acquiring unit, information on second brightness setting information, the second brightness setting information making it possible to print an image of substantially the same brightness as an image printed using the first brightness setting information after the change; and a setting information changing unit that changes, on the basis of the information calculated by the calculating unit, setting content of the second brightness setting information.

### BACKGROUND OF THE INVENTION

1. Field of the Invention

The present invention relates to an image processing technique, and, more particularly to a technique for performing color adjustment for images.

2. Description of the Related Art

In recent years, there has been an increasing demand for color print because of colorization of documentation application software (word processor, spread sheet, and rendering software) and spread of the same.

When the color print is performed using such application software, a document may be printed in colors undesirable for a user. In particular, when a corporate mark (a logo) or the like for which accurate colors are indispensable is printed, the mark may be printed in colors slightly deviating from desired colors.

This is caused by a design of color conversion parameters of a printer. The color conversion parameters of the printer are basically designed to print accurate colors. On the other hand, since various figures, characters, and natural images are objects of printing, the color conversion parameters are fine tuned such that, when the respective objects are printed, average users feel that colors are preferable. For example, the color conversion parameters are fine tuned to be slightly bright or slightly strong in contrast such that preferable colors are obtained. Therefore, slight deviation may occur in colors of the print of the corporate mark requiring accurate colors.

Even when the color conversion parameters are designed to print accurate colors, it is difficult to create the color conversion parameters for accurately printing all colors inputted. An error of colors partially occurs. For example, concerning the corporate mark, every company has different colors of a corporate mark. Thus, although a certain corporate mark can be printed in accurate colors, another corporate mark may be printed in colors deviating from accurate colors. Further, printers have individual differences to some extent, even if color conversion parameters set in a printer in advance are used, it is not always possible to print colors as expected from the color conversion parameters.

Users have different tastes of colors individually. Thus, for example, when a usual red character is printed, a user may feel dissatisfied with red by the color conversion parameters.

As a measure for coping with the problems, there is color adjustment processing. FIG. 19 is a diagram for explaining the color adjustment processing. The color adjustment processing is processing for, for example, correcting color conversion parameters stored in a printer to obtain a print result of desired colors. First, a color adjustment processing unit 801 reads present color conversion parameters set from the printer. It is assumed that the color conversion parameters are stored in a color conversion parameter storing unit 802 arranged in the printer. Then, the color adjustment processing unit 801 reads color adjustment image data for correcting the color conversion parameters. This color adjustment image data is image data usually including plural different color patches prepared in advance. These color patches are treated as color data inputted to the printer. The color adjustment processing unit 801 corrects the color conversion parameters to obtain desired colors from this color data. The color conversion parameters corrected are stored in the color conversion parameter storing unit 802 in the printer again.

FIG. 20 is a diagram for explaining color conversion paths for performing color conversion processing for an input image using the color conversion parameters adjusted as described above. Conventionally, a color printer often has two color conversion paths. One path (a path 1) of the two color conversion paths is used when a color signal inputted is a chromatic color. The path 1 has a role of converting color signals inputted (e.g., RGB signals) into color signals (CMYK) corresponding to color materials of the printer. The other path (a path 2) of the two color conversion paths is a path used only when a color signal inputted is substantially an achromatic color. The path 2 is a path for converting a color inputted such that the color is reproduced by only a black (K) color material of the printer.

Effects of the path 2 will be explained using FIGS. 21 and 22.

FIG. 21 is a result of color conversion by the path 1 at the time when a character of a 50% achromatic color (R=G=B=50%) is inputted. The color conversion result is, for example, C=20%, M=10%, Y=10%, and K=30%. These colors are printed by an image forming unit 803. However, the image forming unit 803 usually has some output position deviation, which is a mechanical instability factor. Thus, respective data of CMYK are not always outputted to an identical position. In other words, an output result shown in FIG. 22 may be obtained. In this case, in a contour portion of a character outputted, color blurring occurs to cause image quality deterioration.

FIGS. 23 and 24 are diagrams for explaining color conversion processing by the path 2 at the time when the same character of the 50% achromatic color is inputted. As shown in FIG. 23, since a result of color conversion by the path 2 is only a black (K) color material, even if positional deviation occurs in the image forming unit 803, blurring of a contour portion does not occur as shown in FIG. 24. Thus, image quality deterioration does not occur.

In this way, it is possible to perform color conversion without deteriorating an image quality by using the path 2 when a color signal inputted is substantially an achromatic color. The path 2 is effective only when an input is substantially an achromatic color. Thus, as shown in FIG. 20, a judging unit 901 is provided, processing by a color converting unit 902 is performed using the path 1 when a color signal inputted is a chromatic color, and processing by an achromatic color gradation adjusting unit 903 is performed using the path 2 when a color signal inputted is an achromatic color.

The conventional color adjustment processing in such a constitution is performed by correcting TRC (Tone Reproduction Curve) parameters used in the path 2 using a TRC adjusting unit 904 as shown in FIG. 25.

However, the conventional color adjustment processing described above has the following problems.

FIG. 26 is a diagram showing a result of printing an image without performing the color adjustment processing described above. FIG. 27 is a diagram showing which image area of the image of the print result shown in FIG. 26 is subjected to the color conversion processing by the path 1 and the path 2.

As shown in the figures, even when an image including a color signal processed by the path 1 and the path 2 is inputted, since color conversion parameters and a TRC are adjusted in advance, as shown in FIG. 26, it is possible to print the image without causing a sense of incongruity even in a boundary between the path 1 and the path 2.

When a user feels the color printed (see FIG. 26) undesirable and desires to increase brightness of the printed image in such a state, the user corrects the TRC parameters to increase brightness of the print result using the TRC adjusting unit of the constitution shown in FIG. 25.

However, in the conventional constitution shown in FIG. 25, only the TRC parameters of the path 2 are corrected. Thus, in an output result after the correction of the TRC parameters (after the color adjustment processing), as shown in FIG. 28, a boundary of processing between an image area subjected to color conversion by the path 1 and an image area subjected to color conversion by the path 2 (a path to which the color adjustment processing is applied) may appear, resulting in an unnatural print result.

### SUMMARY OF THE INVENTION

The invention has been devised to solve the problems described above and it is an object of the invention to provide a technique for preventing image quality deterioration of a print image involved in adjustment of color conversion parameters in image formation processing.

An image processing apparatus according to the invention includes: a change information acquiring unit that acquires, when one of first brightness setting information and second brightness setting information is changed, information on the change, the first brightness setting information defining, in printing a color that can be represented by only a color material of black, brightness that should be represented using the color material and the second brightness setting information defining, in printing a color represented by color materials of plural colors, brightness that should be represented using the color materials; a calculating unit that calculates, on the basis of the change information acquired by the change information acquiring unit, information on the other of the first brightness setting information and the second brightness setting information, the information making it possible to print an image of substantially the same brightness as an image printed using the brightness setting information after the change; and a setting information changing unit that changes, on the basis of the information calculated by the calculating unit, setting content of the other of the first brightness setting information and the second brightness setting information.

An image processing method according to the invention includes: a change information acquiring step of acquiring, when one of first brightness setting information and second brightness setting information is changed, information on the change, the first brightness setting information defining, in printing a color that can be represented by only a color material of black, brightness that should be represented using the color material and the second brightness setting information defining, in printing a color represented by color materials of plural colors, brightness that should be represented using the color materials; a calculating step of calculating, on the basis of the change information acquired in the change information acquiring step, information on the other of the first brightness setting information and the second brightness setting information, the information making it possible to print an image of substantially the same brightness as an image printed using the brightness setting information after the change; and a setting information changing step of changing, on the basis of the information calculated in the calculating step, setting content of the other of the first brightness setting information and the second brightness setting information.

An image processing program according to the invention causes a computer to execute: a change information acquiring step of acquiring, when one of first brightness setting information and second brightness setting information is changed, information on the change, the first brightness setting information defining, in printing a color that can be represented by only a color material of black, brightness that should be represented using the color material and the second brightness setting information defining, in printing a color represented by color materials of plural colors, brightness that should be represented using the color materials; a calculating step of calculating, on the basis of the change information acquired in the change information acquiring step, information on the other of the first brightness setting information and the second brightness setting information, the information making it possible to print an image of substantially the same brightness as an image printed using the brightness setting information after the change; and a setting information changing step of changing, on the basis of the information calculated in the calculating step, setting content of the other of the first brightness setting information and the second brightness setting information.

### DESCRIPTION OF THE DRAWINGS

In the accompanying drawings:

FIG. 1 is a functional block diagram for explaining an image processing apparatus according to an embodiment of the invention;

FIG. 2 is a diagram for explaining processing in a color converting unit 902;

FIG. 3 is a diagram for explaining processing in an achromatic color gradation adjusting unit 903;

FIG. 4 is a diagram for explaining color indicating means;

FIG. 5 is a diagram showing a relation between present L* and corrected L*;

FIG. 6 is a diagram for explaining a TRC correction procedure;

FIG. 7 is a diagram for explaining the TRC correction procedure;

FIG. 8 is a diagram for explaining the TRC correction procedure;

FIG. 9 is a diagram for explaining the TRC correction procedure;

FIG. 10 is a diagram for explaining a corrected TRC and a K″ value obtained by an interpolation operation;

FIG. 11 is a diagram for explaining the corrected TRC and the K″ value obtained by the interpolation operation;

FIG. 12 is a diagram showing a color conversion table before correction;

FIG. 13 is a diagram for explaining an L* value of achromatic color reproduction at the time when the corrected TRC is used;

FIG. 14 is a diagram showing a case in which only the L* value of respective L*, a*, and b* of all input addresses is changed to corrected L′;

FIG. 15 is a diagram for explaining C′, M′, Y′, and K′ values corresponding to corrected L′ab;

FIG. 16 is a diagram showing a state in which C, M, Y, and K values of the present color conversion table in FIG. 12 are replaced with the C′, M′, Y′, and K′ values calculated in FIG. 15;

FIG. 17 is a diagram showing a print result at “brightness +2” desired by a user;

FIG. 18 is a flowchart for explaining a flow of processing in the image processing apparatus according to the embodiment;

FIG. 19 is a diagram for explaining color adjustment processing;

FIG. 20 is a diagram for explaining a color conversion path that performs color conversion processing of an input image using color conversion parameters adjusted as described above;

FIG. 21 is a diagram for explaining an effect of a path 2;

FIG. 22 is a diagram for explaining the effect of the path 2;

FIG. 23 is a diagram for explaining color conversion processing by the path 2 at the time when a character of a 50% achromatic color is inputted;

FIG. 24 is a diagram for explaining the color conversion processing by the path 2 at the time when the character of the 50% achromatic color is inputted;

FIG. 25 is a diagram for explaining the conventional color adjustment processing for correcting only TRC parameters used in the path 2;

FIG. 26 is a diagram showing a result of printing an image without performing color adjustment processing;

FIG. 27 is a diagram showing which image area in the image of the print result shown in FIG. 26 is subjected to color conversion processing by the path 1 and the path 2; and

FIG. 28 is a diagram for explaining a deficiency due to the conventional color adjustment processing.

### DESCRIPTION OF THE EMBODIMENTS

An embodiment of the invention will be hereinafter explained with reference to the drawings.

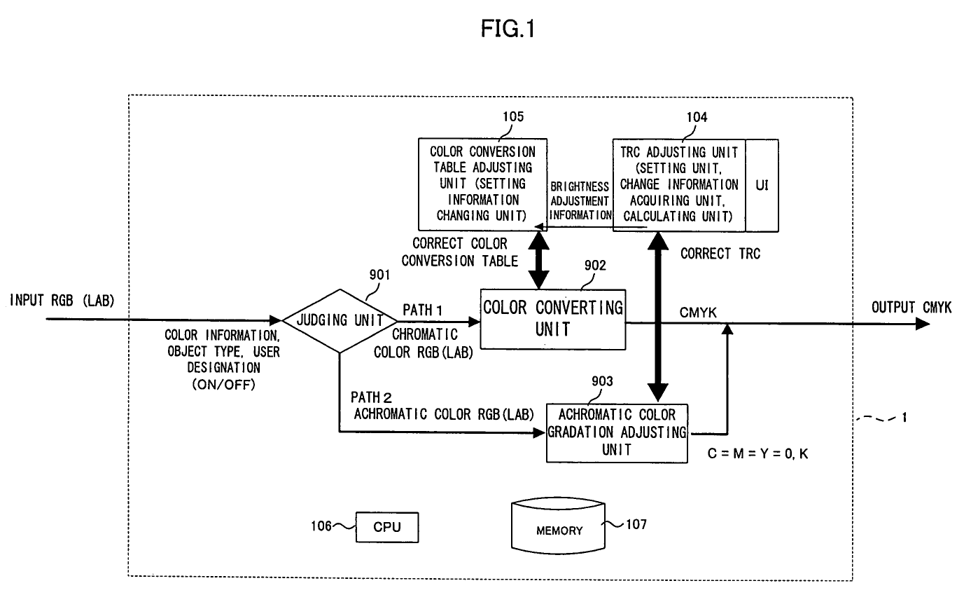

FIG. 1 is a functional block diagram for explaining an image processing apparatus according to this embodiment. An image processing apparatus 1 according to this embodiment is constituted by, for example, an MFP (Multi Function Peripheral) and includes a judging unit 901, a color converting unit 902, an achromatic color gradation adjusting unit 903, a TRC adjusting unit (equivalent to a setting unit, a change information acquiring unit, and a calculating unit) 104, a color conversion table adjusting unit (equivalent to a setting information changing unit) 105, a CPU 106, and a MEMORY 107.

In the following explanation, components identical with those described in the description of the related art are denoted by the identical reference numerals and signs. Explanations of the components are omitted.

When a TRC defining, in printing a color that can be represented by only a color material of black, brightness that should be represented using the color material is changed, the TRC adjusting unit 104 acquires information on the change. The TRC adjusting unit 104 includes a keyboard and a mouse for receiving an operation input of a user and includes a display for performing screen display of various kinds of information. It is assumed that the TRC adjusting unit 104 realizes a function of receiving an operation input and a function of performing screen display using a touch panel display.

The TRC adjusting unit 104 calculates, on the basis of the change information acquired, brightness adjustment information concerning a color conversion table defining, in printing a color represented by color materials of plural colors (cyan, magenta, yellow, and black) that make it possible to print an image of substantially the same brightness as an image printed using brightness setting information after the change, brightness that should be represented using the color materials.

The color conversion table adjusting unit 105 changes, on the basis of the brightness adjustment information calculated by the TRC adjusting unit 104, setting content of the color conversion table.

The TRC adjusting unit 104 has a function of setting necessity of processing for changing the setting content of the brightness setting information by the color conversion table adjusting unit 105. When the processing for changing the setting content of the brightness setting information is set as unnecessary by the TRC adjusting unit 104, the color conversion table adjusting unit 105 does not perform the change of the setting content of the brightness setting information.

The CPU 106 also has a role of performing various kinds of processing in the image processing apparatus 1 and also has a role of realizing various functions by executing programs stored in the MEMORY 107. The MEMORY 107 is constituted by, for example, a ROM, a RAM, and the like and has a role of storing various kinds of information and programs used in the image processing apparatus 1.

Details of functions of the respective components in the image processing apparatus 1 according to this embodiment will be explained.

The judging unit 901 judges on which of the path 1 and the path 2 a color signal inputted is subjected to the color conversion processing and divides the color signal to the path 1 or the path 2 according to a result of the judgment. For example, when a color signal inputted is represented by an RGB color space, the judging unit 901 judges whether the color signal is a chromatic color or an achromatic color. A judgment method is indicated by, for example, Expression (1).

abs(R−G)≦Th1&&abs(G−B)≦Th1&&abs(B−R)≦Th1 (1)

When RGB signal values inputted are substantially equal (a difference is within Th), it is judged that the color signal is an achromatic color. Th1 is an appropriate threshold (e.g., 0 to 5). When the condition of Expression (1) is not satisfied, it is judged that the color signal is a chromatic color.

When a color signal inputted is represented by a CIELAB color space, an “L*” value of the color signal represents a brightness component and “a*” and “b*” thereof represent color difference components. Thus, it is possible to judge the color signal according to, for example, Expression (2).

abs(a*)≦Th2&&abs(b*)≦Th2 (2)

When a* and b* of a CIELAB signal inputted is within a predetermined threshold Th2, it is judged that the signal is an achromatic color. When the condition of Expression (2) is not satisfied, it is judged that the signal is a chromatic color. The input color signal is sent to the path 1 or the path 2 on the basis of such a result of the judgment.

The judging unit 901 may judge color conversion processing for a color signal inputted and divide the color signal on the basis of conditions other than the color signal. For example, there is a condition of object types indicating what kind of image a color signal inputted is. The types of objects include a photograph object, a character object, and a graphic object. For example, in the case of the character object and the graphic object, a color signal is divided according to the judgment described above. In the case of the photograph object, a color signal is forcibly divided to the path 1 without the judgment. There is also a function of determining whether the judgment is performed according to a condition designated by the user. In this case, the judgment is not performed and the path 1 is always used.

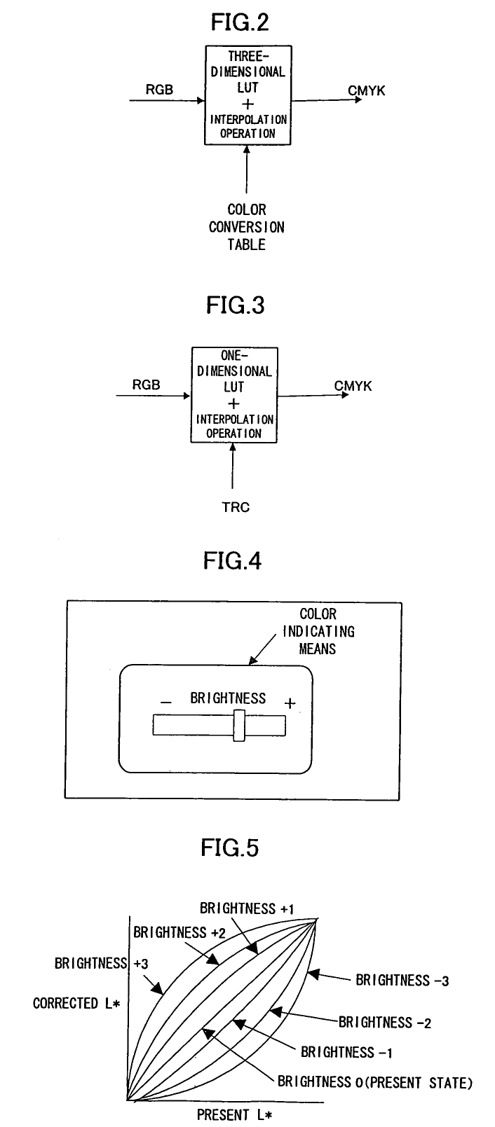

The color converting unit 902 is color converting means provided for the path 1. Processing of the color converting unit 902 is shown in FIG. 2 as an example. In FIG. 2, a color space inputted is RGB (Red, Green, and Blue) and a color space outputted is CMYK. The color converting unit 902 has a three-dimensional LUT (Lookup Table). Data determining what kinds of RGB values inputted should be converted into what kinds of CMYK values in advance is stored in the three-dimensional LUT. This data is equivalent to a color conversion table in the color converting unit 902 shown in FIG. 2. The respective values of RGB inputted are often values of about 256 kinds (8 bits). Combinations in this case are as many as about 16.7 million. It is unpractical to directly use the combinations as three-dimensional LUT data in terms of a memory capacity. Thus, usually, respective axes of the input RGB values are divided into several parts and CMYK values corresponding to combinations of RGB values at lattice points formed by the division are stored in the three-dimensional LUT as three-dimensional LUT data.

The data is stored in the three-dimensional LUT in this way. When combinations of the input RGB values are present in the three-dimensional LUT, CMYK values of the three-dimensional LUT data are outputted. When combinations of the input RGB values are not present in the three-dimensional LUT, plural lattice points (e.g., eight points) around the input RGB values are extracted and CMYK values of the three-dimensional LUT data corresponding to the plural lattice points extracted, respectively, are subjected to an interpolation operation to output CMYK.

When a color space inputted is CIELAB, the color conversion table (second brightness setting information) and the three-dimensional LUT data are set as data determining what kinds of CIELAB values inputted should be converted into what kinds of CMYK values.

The achromatic color gradation adjusting unit 903 will be explained. The achromatic color gradation adjusting unit 903 is present in the path 2 and used when an input color signal is an achromatic color. As an example, processing of the achromatic color gradation adjusting unit 903 is shown in FIG. 3. In FIG. 3, a color space inputted is RGB and a color space outputted is CMYK. As described above, a color signal divided to the path 2 is a color signal judged as an achromatic color by the judging unit. Thus, respective values of RGB inputted are substantially equal. The achromatic color gradation adjusting unit 903 has a one-dimensional LUT (Lookup Table). Data determining what kind of G value (or may be R value or B value) inputted should be converted into what kind of K value in advance is stored in the one-dimensional LUT. This data is equivalent to the TRC (first brightness setting information) in the achromatic color gradation adjusting unit 903 shown in FIG. 3.

The data is stored in the one-dimensional LUT in this way. When the input G value is present in the one-dimensional LUT, a K value of the one-dimensional LUT data is outputted. When the input G value is not present in the one-dimensional LUT, plural points (e.g., two points) around the input G value are extracted and K values of the one-dimensional LUT data corresponding to the plural lattice points extracted, respectively, are subjected to an interpolation operation to output K. CMY values outputted from the achromatic color gradation adjusting unit 903 are always 0 (no-print signal).

When a color space inputted is CIELAB, the TRC and the one-dimensional LUT data are set as data determining what kind of L value inputted should be converted into what kind of K value.

A color signal changed to CMYK values by the path 1 or the path 2 is printed by a not-shown image forming unit. It is determined which CMYK values of the path 1 or the path 2 are used according to on which path the signal is converted (when the path 1 is used, CMYK values from the path 1 are used and, when the path 2 is used, CMYK values from the path 2 are used).

The image forming unit is a printer of, for example, an ink jet system, an electrophotographic system, a thermal transfer system or the like. In this embodiment, any printing system may be adopted.

The TRC adjusting unit 104 corrects a TRC used in the achromatic color gradation adjusting unit 903 according to designation by the user. The TRC adjusting unit 104 includes, for example, color indicating means shown in FIG. 4. The color indicating means has, for example, a slide bar of “brightness” and corrects the TRC according to designation by the user.

The color conversion table adjusting unit 105 corrects the color conversion table used in the color converting unit 902. In the correction, the color conversion table is corrected in accordance with brightness adjustment information (information calculated by the calculating unit) generated when the user adjusts the TRC with the TRC adjusting unit 104.

Operations of the image processing apparatus according to this embodiment will be explained.

For example, when the user prints a pattern shown in FIG. 26, in FIG. 1, a color signal of each pixel of this pattern is inputted to the judging unit 901. The judging unit 901 judges, according to the judging method described above, whether each color signal of the pixel inputted is an achromatic color or a chromatic color. When the color signal is a chromatic color, the judging unit 901 sends the color signal to the path 1 and, when the color signal is an achromatic color, the judging unit 901 sends the color signal to the path 2. A result of color conversion of the path 1 or the path 2 is sent to the not-shown image forming unit according to a division condition and FIG. 27 is printed. For convenience of explanation, a pixel area converted by the path 1 and a pixel area converted by the path 2 are shown in FIG. 27. However, in an actual print result, these lines do not appear.

In this case, when the user looks at FIG. 27, the user may feel that a color near the achromatic color is not a desired color. For example, the user may feel the image dark as a whole. In this case, the user can correct a TRC with the TRC adjusting unit 104 such that a print result of desired brightness is obtained. For example, when the user feels a print result dark and desires to make the print result bright, the user slides the slide bar of “brightness” of the color indicating means in FIG. 4 in a direction for making the print result bright.

The TRC adjusting unit 104 corrects a TRC currently used in accordance with an indication inputted by this color indicating means.

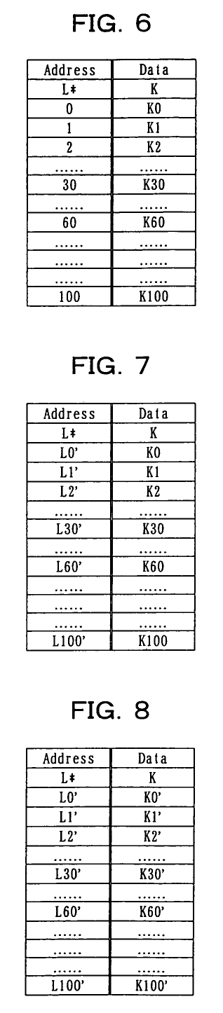

A specific example is described below with an input address of a TRC set as L* (L* of CIELAB) and a table value set as K. The TRC is related to a value of the “brightness” slide bar of the color indicating means and defines a relation between present L* and corrected L* shown in FIG. 5. For example, when the user indicates +2 in the direction for making the print result bright, a curve of brightness +2 in FIG. 5 is selected and it is determined to what kind of corrected L* this curve changes the present L*. A procedure for correcting a TRC is shown in FIGS. 6 to 9. FIG. 6 shows a present TRC. An input address of the TRC is 101 points obtained by dividing L* by 100. Since the corrected L* corresponding to the present L* is found according to the brightness +2 curve in FIG. 5, as shown in FIG. 7, the input address is changed to L′.

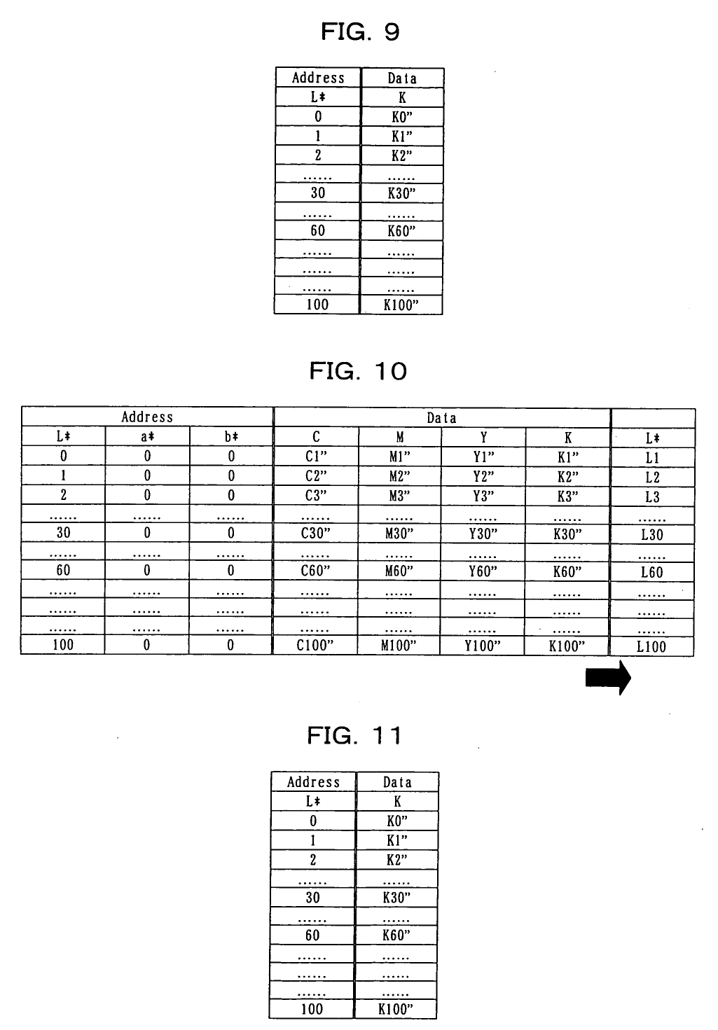

Subsequently, as shown in FIG. 8, a K′ value corresponding to the corrected L′ is calculated by the same arithmetic operation as the arithmetic operation of the achromatic color gradation adjusting unit 903. A TRC used in this case is the present TRC (FIG. 6). As shown in FIG. 9, the K value of the present TRC in FIG. 6 is replaced with the K′ value calculated in FIG. 8. According to the processing, the TRC indicated by the user as “brightness +2”, that is, a corrected TRC is formed and used in the achromatic color gradation adjusting unit 903 of the path 2 in FIG. 1. Thus, an achromatic color passing through the path 2 is “brightness +2”.

The TRC adjusting unit 104 calculates brightness adjustment information using the corrected TRC. The brightness adjustment information is a K″ value obtained from the corrected TRC and an interpolation operation when an input L* equivalent to an achromatic color is inputted (see FIGS. 10 and 11). The achromatic color in this case is in a range of white (L=100) to black (L=0).

The color conversion table adjusting unit 105 corrects the color conversion table used in the color converting unit 902. In the correction, the color conversion table is corrected in accordance with the brightness adjustment information generated when the user adjusts the TRC with the TRC adjusting unit 104. An example of correction of the color conversion table is described below.

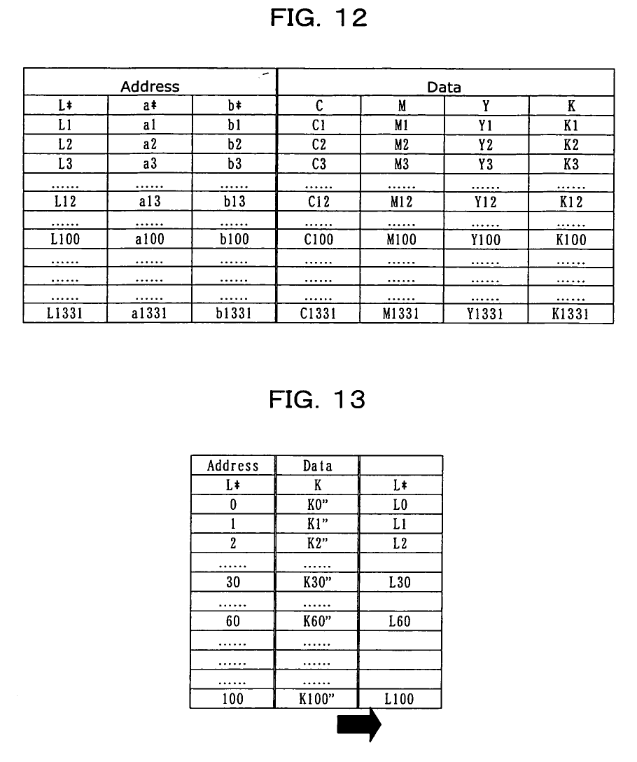

A present color conversion table (before correction) is shown in FIG. 12.

In the color conversion table, lattice points on respective axes of L*, a*, and b* equivalent to units of an input address are 11 points. L*, a*, and b* of combinations of the lattice points are input addresses (1331 in total).

First, an L* value of achromatic color reproduction at the time when the corrected TRC of the path 2 is used is calculated from the brightness adjustment information. In other words, brightness of a color at the time when the table value K″ in FIG. 11 is actually printed by an output device is calculated. Therefore, the color conversion table adjusting unit 105 holds color output characteristic data of the output device, that is, data indicating what kind of color (Lab) is outputted when a color is printed with what kind of K. A result of the calculation is shown in FIG. 13.

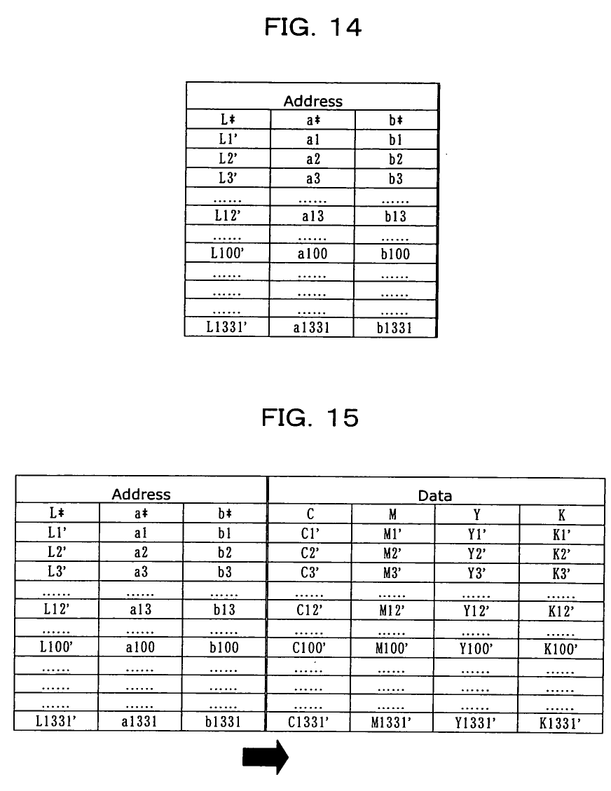

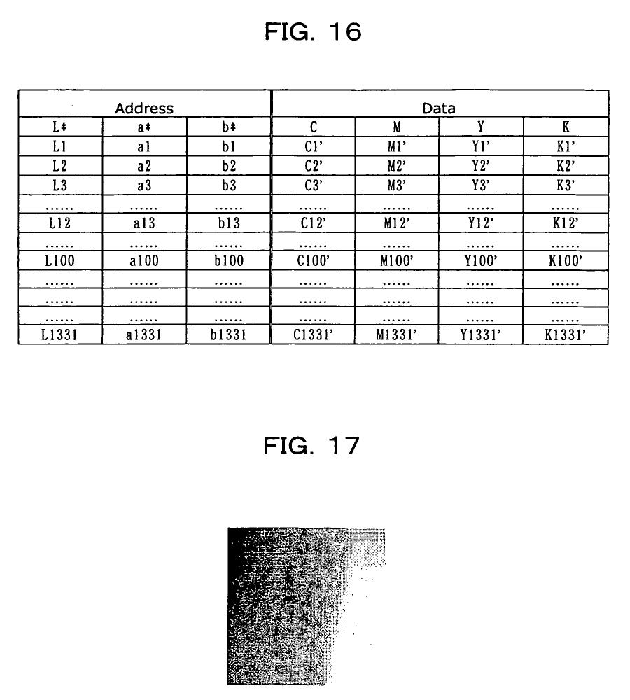

Subsequently, as shown in FIG. 14, only the L* value of the respective L*, a*, and b* of all the input addresses is changed to corrected L′ in accordance with L* in FIG. 11. As shown in FIG. 15, C′M′Y′K′ values corresponding to corrected L′ab are calculated by the same arithmetic operation as the arithmetic operation of the color converting unit 902. A color conversion table used in this case is the present color conversion table (FIG. 12). As shown in FIG. 16, the CMYK values of the present color conversion table in FIG. 12 are replaced with the C′M′Y′K′ values calculated in FIG. 15.

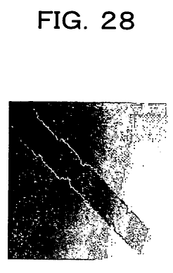

Consequently, the color conversion table and the TRC are corrected according to the indication “brightness +2” by the user. Thus, the conventional problem in that a boundary of processing of the path 1 and the path 2 (paths to which the color adjustment processing is applied) appears as shown in FIG. 28 in an output result after the TRC correction (after the color adjustment processing), resulting in an unnatural output result, does not occur. As shown in FIG. 17, all the processing areas of the path 1 and the path 2 have “brightness +2” desired by the user.

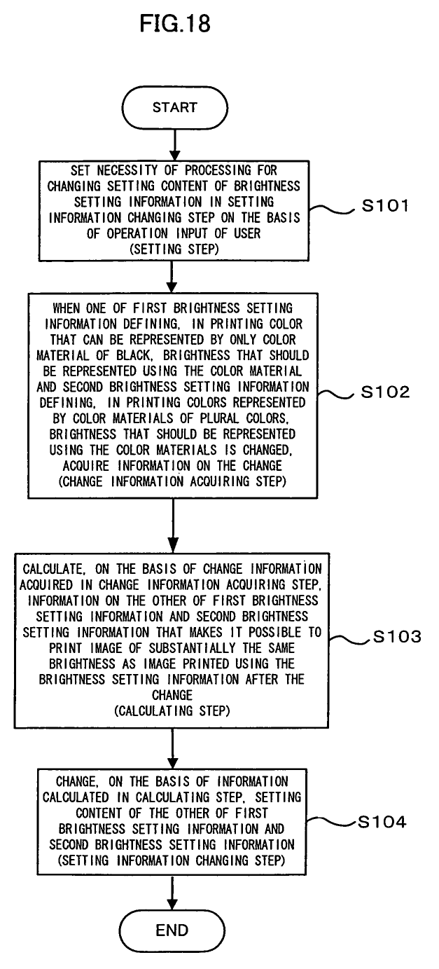

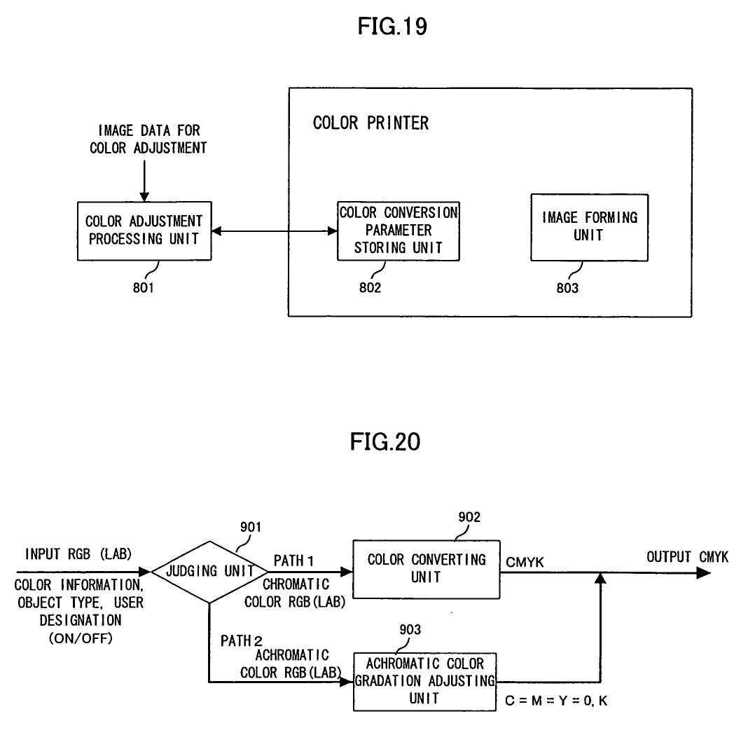

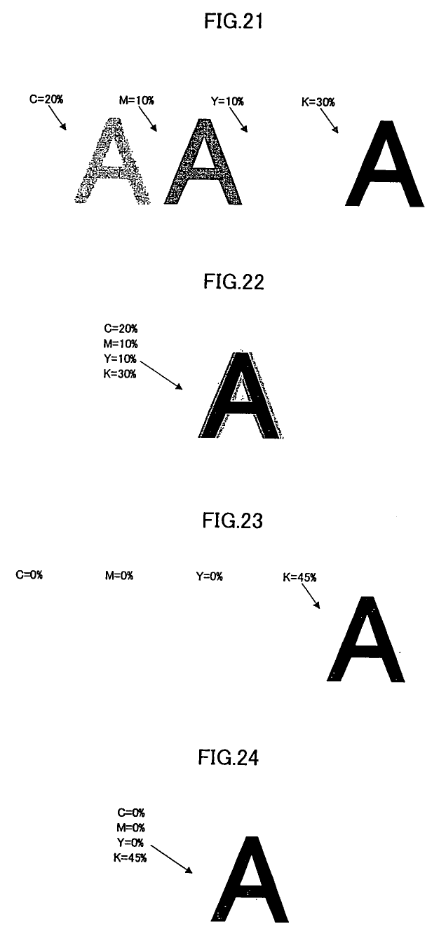

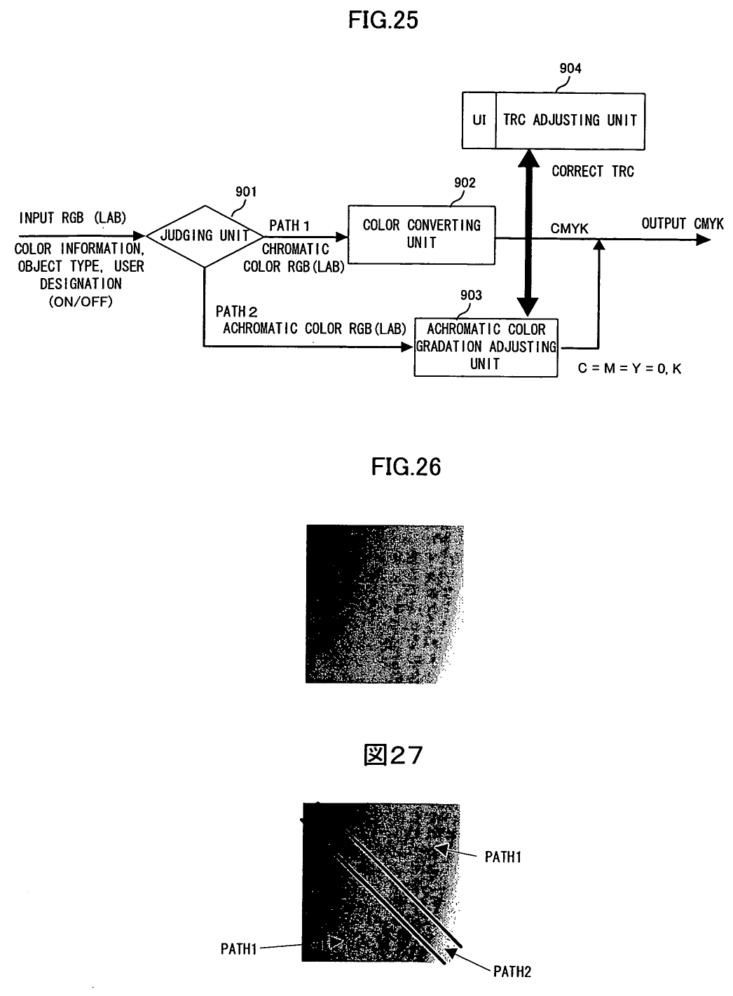

FIG. 18 is a flowchart for explaining a flow of processing in the image processing apparatus according to this embodiment.

The TRC adjusting unit 104 sets necessity of processing for changing setting content of brightness setting information in a setting information changing step (described later) on the basis of an operation input of the user (a setting step) (S101).

When one of first brightness setting information defining, in printing a color that can be represented by only a color material of black, brightness that should be represented using the color material and second brightness setting information defining, in printing colors represented by color materials of plural colors (cyan, magenta, yellow, and black), brightness that should be represented using the color materials is changed, the TRC adjusting unit 104 acquires information on the change (a change information acquiring step) (S102).

The TRC adjusting unit 104 calculates, on the basis of the change information acquired in the change information acquiring step, information on the other of the first brightness setting information and the second brightness setting information that makes it possible to print an image of substantially the same brightness as an image printed using the brightness setting information after the change (a calculating step) (S103).

The color conversion table adjusting unit 105 changes, on the basis of the information calculated in the calculating step, the setting content of the other of the first brightness setting information and the second brightness setting information (a setting information changing step) (S104). When the processing for changing the setting content of the brightness setting information is set as unnecessary in the setting step, in the setting information changing step, the change of the setting content of the brightness setting information is not performed.

The respective steps in the processing in the image processing apparatus are realized by causing the CPU 106 to execute an image processing program stored in the MEMORY 107.

In the explanation of this embodiment, the functions of carrying out the invention are recorded in the apparatus in advance. However, the invention is not limited to this. The same functions may be downloaded from a network to the apparatus or the same functions stored in a recording medium may be installed in the apparatus. A form of the recording medium may be any form as long as the recording medium is a recording medium that can store programs and is readable by the apparatus such as a CD-ROM. The functions obtained by installation or download in advance in this way may be realized in cooperation with an OS (operating system) or the like in the apparatus.

According to this embodiment, the color conversion table is automatically corrected simultaneously with the TRC table of color areas reproduced by only the color material K in accordance with an instruction of the user. Thus, There is an effect that the user can perform color adjustment of a printer easily and as intended.

The invention has been explained in detail according to the specific embodiment. However, it would be apparent to those skilled in the art that various alterations and modifications can be made without departing from the spirit and the scope of the invention.

As described above in detail, according to the invention, it is possible to provide a technique for preventing image quality deterioration of a print image involved in adjustment of the color conversion parameters in the image formation processing.

What is claimed is:

1. An image processing apparatus comprising:
a change information acquiring unit that acquires, when one of first brightness setting information and second brightness setting information is changed, information on the change, the first brightness setting information defining, in printing a color that can be represented by only a color material of black, brightness that should be represented using the color material and the second brightness setting information defining, in printing colors represented by color materials of plural colors, brightness that should be represented using the color materials;
a calculating unit that calculates, on the basis of the change information acquired by the change information acquiring unit, information on the other of the first brightness setting information and the second brightness setting information, the information making it possible to print an image of substantially the same brightness as an image printed using the brightness setting information after the change; and
a setting information changing unit that changes, on the basis of the information calculated by the calculating unit, setting content of the other of the first brightness setting information and the second brightness setting information.

2. An image processing apparatus according to claim 1, wherein
the change information acquiring unit acquires, when the first brightness setting information is changed, information on the change, the first brightness setting information defining, in printing a color that can be represented by only a color material of black, brightness that should be represented using the color material,
the calculating unit calculates, on the basis of the change information acquired by the change information acquiring unit, information on the second brightness setting information defining, in printing colors represented by color materials of plural colors, brightness that should be represented using the color materials, the information making it possible to print an image of substantially the same brightness as an image printed using the first brightness setting information after the change, and
the setting information changing unit changes, on the basis of the information calculated by the calculating unit, the setting content of the second brightness setting information.

3. An image processing apparatus according to claim 1, wherein the first brightness setting information is information on a gradation representation curve.

4. An image processing apparatus according to claim 1, further comprising a setting unit that sets, on the basis of an operation input of a user, necessity of processing for changing the setting content of the brightness setting information by the setting information changing unit, wherein
the setting information changing unit does not change the setting content of the brightness setting information when the processing for changing the setting content of the brightness setting information is set as unnecessary by the setting unit.

5. An image processing apparatus according to claim 1, wherein the color materials of plural colors are color materials of cyan, magenta, yellow, and black.

6. An image processing method comprising:
a change information acquiring step of acquiring, when one of first brightness setting information and second brightness setting information is changed, information on the change, the first brightness setting information defining, in printing a color that can be represented by only a color material of black, brightness that should be represented using the color material and the second brightness setting information defining, in printing colors represented by color materials of plural colors, brightness that should be represented using the color materials;
a calculating step of calculating, on the basis of the change information acquired in the change information acquiring step, information on the other of the first brightness setting information and the second brightness setting information, the information making it possible to print an image of substantially the same brightness as an image printed using the brightness setting information after the change; and
a setting information changing step of changing, on the basis of the information calculated in the calculating step, setting content of the other of the first brightness setting information and the second brightness setting information.

7. An image processing method according to claim 6, wherein
in the change information acquiring step, when the first brightness setting information is changed, information on the change is acquired, the first brightness setting information defining, in printing a color that can be represented by only a color material of black, brightness that should be represented using the color material,
in the calculating step, on the basis of the change information acquired in the change information acquiring step, information on the second brightness setting information defining, in printing colors represented by color materials of plural colors, brightness that should be represented using the color materials is calculated, the information making it possible to print an image of substantially the same brightness as an image printed using the first brightness setting information after the change, and
in the setting information changing step, on the basis of the information calculated by the calculating unit, the setting content of the second brightness setting information is changed.

8. An image processing method according to claim 6, wherein the first brightness setting information is information on a gradation representation curve.

9. An image processing method according to claim 6, further comprising a setting step of setting, on the basis of an operation input of a user, necessity of processing for changing the setting content of the brightness setting information in the setting information changing step, wherein
in the setting information changing step, the setting content of the brightness setting information is not changed when the processing for changing the setting content of the brightness setting information is set as unnecessary in the setting step.

10. An image processing method according to claim 6, wherein the color materials of plural colors are color materials of cyan, magenta, yellow, and black.

11. An image processing program that causes a computer to execute:
a change information acquiring step of acquiring, when one of first brightness setting information and second brightness setting information is changed, information on the change, the first brightness setting information defining, in printing a color that can be represented by only a color material of black, brightness that should be represented using the color material and the second brightness setting information defining, in printing colors represented by color materials of plural colors, brightness that should be represented using the color materials;
a calculating step of calculating, on the basis of the change information acquired in the change information acquiring step, information on the other of the first brightness setting information and the second brightness setting information, the information making it possible to print an image of substantially the same brightness as an image printed using the brightness setting information after the change; and
a setting information changing step of changing, on the basis of the information calculated in the calculating step, setting content of the other of the first brightness setting information and the second brightness setting information.

12. An image processing program according to claim 11, wherein
in the change information acquiring step, when the first brightness setting information is changed, information on the change is acquired, the first brightness setting information defining, in printing a color that can be represented by only a color material of black, brightness that should be represented using the color material,
in the calculating step, on the basis of the change information acquired in the change information acquiring step, information on the second brightness setting information defining, in printing colors represented by color materials of plural colors, brightness that should be represented using the color materials is calculated, the information making it possible to print an image of substantially the same brightness as an image printed using the first brightness setting information after the change, and
in the setting information changing step, on the basis of the information calculated by the calculating unit, the setting content of the second brightness setting information is changed.

13. An image processing program according to claim 11, wherein the first brightness setting information is information on a gradation representation curve.

14. An image processing program according to claim 11, further comprising a setting step of setting, on the basis of an operation input of a user, necessity of processing for changing the setting content of the brightness setting information in the setting information changing step, wherein
in the setting information changing step, the setting content of the brightness setting information is not changed when the processing for changing the setting content of the brightness setting information is set as unnecessary in the setting step.

15. An image processing program according to claim 11, wherein the color materials of plural colors are color materials of cyan, magenta, yellow, and black.
